(19) United States
(12) Patent Application Publication
(10) Pub. No.: US 2012/0237708 A1
(43) Pub. Date: Sep. 20, 2012

(54) CASING BODY

(75) Inventors: Heinz Caviezel, Masein (CH); Roland Treutlein, Pirk (DE); Ulrich Presenz, Trin (CH); Mark Pfleghar, Domat/Ems (CH)

(73) Assignee: EMS-PATENT AG, Domat/Ems (CH)

(21) Appl. No.: 13/421,541

(22) Filed: Mar. 15, 2012

(30) Foreign Application Priority Data
Mar. 17, 2011 (EP) 11 002 218.3

(51) Int. Cl. B32B 1/08

(52) U.S. Cl. 428/36.5

(57) ABSTRACT

Disclosed is a casing body (1) made of a thermoplastic plastic material, in particular for cosmetic pencils or writing pencils, the cavity H of which is enclosed by an at least three-shell construction A, Z, I, it having 1 to 10 outer shells A, an intermediate shell Z and 1 to 10 inner shells I, the intermediate shell Z including a polyamide foam and at least one of the other shells A, I including a polyamide.

CROSS-REFERENCE TO A RELATED APPLICATION

This application claims the benefit of European Patent Application No. 11 002 218.3, filed Mar. 17, 2011, the disclosure of which is incorporated herein by reference.

### BACKGROUND OF THE INVENTION

The invention relates to a casing body made of a thermoplastic plastic material having a shell construction, at least three shells being provided and one shell forming an intermediate shell comprising polyamide foam and/or consisting thereof and at least another shell comprising polyamide and/or consisting thereof. The invention relates furthermore to the use of such a casing body, in particular for cosmetic pencils, writing pencils and industrial applications.

Casing bodies for cosmetic pencils and writing pencils or cosmetic pencils and writing pencils which have a covering made of plastic material are known in the state of the art.

Thus it is described for example in the British patent 1 538 188 that the cartridge used for the cosmetic pencils and made of a cosmetic material is poured into the casing body of the pencil. Furthermore, the German patent 40 05 894 describes a method and cosmetic pencils having a relatively thin cartridge and also a sharpenable casing body made of plastic material using axially moveable casting needles. Furthermore, also methods are known for the production of casing bodies for cosmetic pencils by means of injection moulding, these casings being able to be filled with a cosmetic material which is liquefied by heating. In this respect, there may be mentioned for example U.S. Pat. Nos. 4,413,921 and 5,957,607.

To date, preferably foamed PVC has thereby been used in the state of the art as plastic material.

It is disadvantageous with casing bodies or with cosmetic pencils which have a foamed PVC casing that the barrier properties relative to the solvent of the cartridge, generally isododecane, are merely inadequate. Furthermore, it can be criticised in the state of the art that, in the production of such pencils, only a low production speed can be achieved. It is also a disadvantage that freedom from chlorine cannot be guaranteed when using PVC as covering material and that the haptics of the pencils are in need of improvement.

### BRIEF SUMMARY OF THE INVENTION

Starting herefrom it is therefore the object of the present invention to indicate a casing body made of a thermoplastic plastic material, in particular for cosmetic pencils or writing pencils, which, in addition to freedom from chlorine and excellent haptics, has also a good barrier property relative to the solvents of the cartridge. At the same time, these casing bodies are intended to be producible at a high production speed in order to reduce the production costs.

This object is achieved by the features of the casing body described herein, and the advantageous developments thereof.

### BRIEF DESCRIPTION OF THE DRAWINGS

FIG. 1 depicts a casing body in accordance with an embodiment of the invention.

FIG. 2 depicts a casing body in accordance with other embodiments of the invention.

FIG. 3 depicts properties of casing body Examples 1-9.

FIG. 4 depicts properties of casing body Examples 10-20.

FIG. 5 depicts polyamide components in accordance with an embodiment of the invention.

FIG. 6 depicts certain components in accordance with an embodiment of the invention.

### DETAILED DESCRIPTION OF THE INVENTION

According to the invention, it is hence proposed that the casing body has at least one to at most ten outer shells, an intermediate shell and at least one to at most ten inner shells, the intermediate shell comprising polyamide foam and/or consisting thereof and at least one of the other shells comprising polyamide and/or consisting thereof.

The proposed layer construction according to the invention has numerous advantages. Thus is it possible to produce the casing body by means of a coextrusion process in one operation, the inventors having been able to show that significantly increased production speeds could be achieved therewith relative to the state of the art. Furthermore, it must be stressed that, by means of the shell construction, also specific influencing of the mechanical and physical properties can be achieved. Thus excellent barrier properties can be produced by specific influencing of the shell material and furthermore also the haptics of the casing bodies to be produced can be controlled specifically by providing a specifically selected outer shell. The use of polyamide as shell material has the further advantage that freedom from chlorine can be guaranteed therewith and that it is possible to improve also the mechanical properties and the sharpenability, by addition for example of selective additives.

It is an essential element of the present invention that the intermediate shell is formed from polyamide foam. This intermediate shell made of polyamide foam has then preferably a greater layer thickness than the layer thickness of the other shells, i.e. the internally situated shells which surround the cavity and those shells which are directed outwards. The intermediate shell Z has preferably a layer thickness of 1,000 to 3,000 μm, preferably of 1,100 to 2,500 μm, particularly preferred of 1,200 to 2,100 μm and very particularly preferred of 1,300 to 1,800 μm.

The shells which comprise polyamide have, in contrast, a layer thickness of 50 to 600 μm, preferably of 80 to 500 μm, particularly preferred of 100 to 400 μm and very particularly preferred of 150 to 300 μm.

A casing body according to the invention, as described above, has excellent maximum strengths in the bending test, which are preferably in the range of 85 to 250 N, further preferred 90 to 180 N and very particularly preferred in the range of 100 to 170 N.

From the point of view of materials, the casing body is constructed such that the polyamide foam which forms the intermediate layer is constructed from an amorphous polyamide and/or a partially crystalline polyamide and a polyamide elastomer and/or modified polyolefin elastomer. The polyamide foam is thereby preferably constructed from an amorphous or partially crystalline polyamide and also a polyamide elastomer and/or a modified polyolefin elastomer. As known in the state of the art, the polyamide foam contains propellants which are customary per se. Examples of propellants are hydrogen carbonates, hydrogen citrates, azodicarbonamides, citric acid, hydrazides, semicarbazides, boron hydrides and mixtures thereof. The propellants are generally diluted by the addition of extenders, such as starch or calcium carbonate, so that 20 to 50% by weight of mixtures are used. As propellants, hydrogen carbonates, hydrogen citrates, azodicarbonamides, citric acid and mixtures thereof are preferred. As propellants, mixtures of sodium hydrogen carbonate, citric acid and calcium carbonate are particularly preferred.

Of the composition with respect to quantities, it is preferred if the polyamide foam comprises 50 to 80%, particularly preferred 60 to 75% by weight, very particularly preferred 65 to 75% by weight of polyamide, and 20 to 50% by weight, particularly preferred 35 to 25% by weight, very particularly preferred 65 to 75% by weight, of a polyamide elastomer and/or of modified polyolefin elastomer, with propellant mixtures having a content of propellant of 30 to 35% by weight, usually 0.4 to 0.75% by weight, preferably 0.45 to 0.65% by weight, are contained.

In the case of the amorphous polyamides for the polyamide foam, those are preferred which have a glass-transition temperature of the amorphous polyamide of 90 to 210° C., preferably 100 to 180° C., particularly preferred 100 to 170° C. Examples in this respect are PA 6I, PA 6I/6T, PA 6I/66/69, PA 6-3-T, PA MACM12 and PA MACMI/12.

The relative viscosity of the amorphous polyamides, measured in solutions of 0.5 g polyamide, in 100 ml solvent in m-cresol at 20° C. is 1.50 to 1.85, preferably 1.55 to 1.80, particularly preferred 1.55 to 1.75.

The proportion of isophthalic acid in the polyamide PA 6I/6T is 90 to 57% by mol, preferably 85 to 60% by mol, particularly preferred 75 to 60% by mol, very particularly preferred 72 to 63% by mol, the sum of both dicarboxylic acids producing 100% by mol.

The proportion of isophthalic acid in the polyamide PA 6I/66/69 is 50 to 80% by mol, preferably 60 to 80% by mol, particularly preferred 65 to 75% by mol, the sum of the three dicarboxylic acids producing 100% by mol. The molar ratio of adipinic acid : sebacic acid in the polyamide PA 6I/66/69 is 1:2 to 2:1, preferably 1:1.5 to 1.5:1, particular preferred 1:1.

The melting point of the partially crystalline polyamides of the polyamide foam is preferably in the range of 120 to 295° C., further preferred at 150 to 280° C., particularly preferred at 170 to 270° C., very particularly preferred at 190 to 255° C. Examples of particularly suitable partially crystalline polyamides are PA MXD6, PA MXD6/MXDI, PA MXD6/66/610, PACM12, PA 6 and PA 6/66.

The relative viscosity of the partially crystalline polyamides comprising MXD or PACM, measured in solutions of 0.5 g polyamide in 100 ml solvent in m-cresol at 20° C. is 1.40 to 1.90, preferably 1.50 to 1.80, particularly preferred 1.55 to 1.75.

The relative viscosity of the partially crystalline polyamides PA 6 or PA 6/66, measured in solutions of 1.0 g polyamide in 100 ml solvent in 96% sulphuric acid at 20° C., is 3.40 to 6.0, preferably 3.7 to 5.70, particularly preferred 4.0 to 5.50.

The proportion of isophthalic acid in the polyamide PA MXD6/MXDI is 2 to 15% by mol, preferably 2 to 12% by mol, particularly preferred 2 to 8% by mol, the sum of both dicarboxylic acids producing 100% by mol.

The proportion of meta-xylylene diamine (MXD) in the polyamide PA MXD6/66/610 is 40 to 90% by mol, preferably 50 to 85% by mol, particularly preferred 60 to 80% by mol, very particularly preferred 70 to 80% by mol, the sum of both diamines producing 100% by mol.

In the case of the polyamide elastomers for the polyamide foam, polyether amides, polyester ether amides and/or polyester amides are preferred. The polyolefin elastomers are selected preferably from acid-modified copolyolefin elastomers and acid-modified blends of a plurality of copolyolefin elastomers.

There should be understood by an acid-modified blend of a plurality of copolyolefin elastomers, a mixture of the components ethylene-propylene copolymer, ethylene-but-1-ene copolymer, propylene-but-1-ene copolymer, polyethylene and/or polypropylene. The mixture is homogenised in the melt, also the acid modification is thereby effected by grafting so that the degree of modification is 0.3 to 1.5% by weight, preferably 0.4 to 1.2% by weight, particularly preferred 0.4 to 1.0% by weight, relative to the mixture.

If the mixture of copolyolefin elastomers is used as a dry blend, i.e. without homogenisation in the melt, then at least a part of the components is already acid-modified, e.g. to such an extent that the degree of modification of the entire dry blend is 0.3 to 1.5% by weight, preferably 0.4 to 1.2% by weight, particularly preferred 0.4 to 1.0% by weight. Possibly, such a dry blend can still be homogenised in addition in the melt.

Furthermore, it is preferred that the at least one acid-modified copolyolefin elastomer or the at least one acid-modified blend of a plurality of copolyolefin elastomers is composed of monomeric units which are selected from the group consisting of ethylene d), propylene e) and but-1-ene f), the previously mentioned monomers being used preferably in the following molar proportions:
d) ethylene: 65-90% by mol, preferably 65-87% by mol, particularly preferred 71-84% by mol,
e) propylene: 8-33% by mol, preferably 10-25% by mol, particularly preferred 12-20% by mol, and also
f) but-1-ene: 2-25% by mol, preferably 3-20% by mol, particularly preferred 4-15% by mol, very particularly preferred 4-9% by mol, and the components d) to f) adding up to 100% by mol.

According to this embodiment, it can hence be provided that the copolyolefin elastomer comprises the mentioned monomers d) to f) in the indicated preferred molar proportions, however the possibility is likewise included that a plurality of copolyolefin elastomers is mixed, which comprises respectively two of the monomers d) to f), i.e. d) and e), d) and f) or e) and f) so that the monomers d) to f) are present in the mixture in the preferred molar proportions. For particular preference, the mixture consists of a copolyolefin elastomer of the monomers d) and e) and a copolyolefin elastomer of the monomers d) and 0 so that the monomers d) to f) are present in the mixture in the preferred molar proportions.

Furthermore, it is advantageous that the acid-modification of the copolyolefin elastomer or of the blend of a plurality of copolyolefin elastomers is effected by grafting with unsaturated carboxylic acids and/or unsaturated carboxylic acid derivatives, preferably a carboxylic acid derivative selected from the group consisting of unsaturated carboxylic acid esters and unsaturated carboxylic acid anhydrides, in particular with an unsaturated carboxylic acid selected from the group consisting of acrylic acid, methacrylic acid, alpha-ethylacrylic acid, maleic acid, fumaric acid, itaconic acid, citraconic acid, aconitic acid, tetrahydrophthalic acid and/or butenyl succinic acid, i.e. that the copolyolefin elastomer comprises grafted unsaturated carboxylic acids and/or unsaturated carboxylic acid derivatives in the molecule. The conditions under which the grafting of the copolyolefin elastomer takes place are known sufficiently to the person skilled in the art.

Advantageous degrees of modification, i.e. the weight proportions of the unsaturated carboxylic acids and/or unsaturated carboxylic acid derivatives on the copolyolefin elastomer or on the blend of a plurality of copolyolefin elastomers, are thereby at 0.3 to 1.5% by weight, preferably at 0.4 to 1.2% by weight, particularly preferred at 0.4 to 1.0% by weight.

With respect to the polyamide of the other shells comprising polyamide or consisting of polyamide, there should be mentioned aliphatic, cycloaliphatic, aromatic polyamides and/or blends hereof.

Suitable examples of polyamides of the shells comprising polyamide or consisting of polyamide are: PA 6, PA 11, PA 12, PA 46, PA 410, PA 412, PA 66, PA 69, PA 610, PA 612, PA 1010, PA 1212, PA 6/11, PA 6/12, PA 6/66, PA 6/68, PA 6/610, PA 66/11, PA 66/12, PA 66/610, PA 6/66/11, PA 6/66/12, PA 6/66/69, PA 6/66/610, PA 6/66/612, PA 6/610/11, PA 6/610/12, PA 6I, PA 6I/6T, PA 6I/66/69, PA 6I/66/610, PA 6-3-T, PA MXD6,PA MXD6/MXDI, PA MXD6/66/610, PA MXDI/6I, PA MACM12, PA PACM12, PA MACM14/1014, PA MACM12/PACM12, PA MACM14/PACM14, PA MACMI/PACMI/12, PA MACMI/12, PA MACMT/12, PA MACMI/MACMT/12, PA 6I/MACMI/12, PA 6I/6T/MACMI/MACMT, PA 6I/6T/MACMI/MACMT/12, PA MACM6/11, PA 6I/6T/MACMI/MACMT/MACM12/612, polyether amides, polyester ether amides and/or polyester amides.

The alphabetical abbreviations of the monomers mean:
I isophthalic acid
T terephthalic acid
MACM bis-(4-amino-3-methyl-cyclohexyl)methane
MXD meta-xylylene diamine
PACM bis-(4-amino-cyclohexyl)methane (PACM).

The polyamide PA 6-3-T is composed of trimethylhexamethylene diamine and terephthalic acid.

In the case of the casing body according to the invention, it is particularly preferred if both the intermediate shell and the inner shells and the outer shells comprise polyamide and/or consist of polyamide. In this case, the casing body is hence constructed exclusively from polyamide.

However, the invention also includes embodiments in which at least one of the shells which are directed outwards and/or one of the inner shells do not comprise polyamide and/or consist of polyamide, instead a different shell material can be used here as a function of the desired properties. According to the present invention, it is only required here that at least one of the shells, which are used in total for the shell construction, is formed from a different polymer. The thickness of this shell, apart from when adhesives are used, is in the range of the shells comprising polyamide. Shells which are formed from one or more adhesives have thicknesses of 3 to 100 μm, preferably of 5 to 50 μm, particularly preferred of 7 to 20 μm. Examples of other polymers are polyolefins, polyesters, polycarbonates, ethylene-vinyl alcohol copolymers and/or shells which are formed from recycling material which originates from the production process of the casing body. In the case of polyesters, polyethylene terephthalate (PET), polybutylene terephthalate (PBT) and polyethylene naphthalate (PEN) are preferred. The term polyolefin includes in this context homopolyolefins, such as e.g. PE or PP, copolyolefins, cycloolefin copolymers (COC), thermoplastic elastomers (TPE), grafted polyolefins, grafted copolyolefins, ionomers, adhesives and copolymers of olefins with acrylic acid, acrylic acid derivatives (e.g. methacrylic acid, acrylonitrile, methacrylic acid methylester, methacrylic acid butylester, glycidylmethacrylate etc.), vinyl acetate, maleic anhydride, further olefins and/or styrene. In the case of the polyolefins, polypropylene, cycloolefin copolymers (COC) and adhesives are particularly preferred.

The components of the polyamide foam, amorphous polyamide and/or partially crystalline polyamide and polyamide elastomer and/or modified polyolefin elastomer are used as compound or dry blend in the production of the polyamide foam. In the case of the compound, the components are mixed in the molten state. This takes place on normal compounding machines, such as e.g. single- or twin-screw extruders or twin-screw compounders. The components are thereby metered individually into the feed or supplied in the form of a dry blend.

For production of the dry blend, the dried granulates and possibly further additives are mixed together. This mixture is homogenised for 10 to 40 minutes by means of an eccentric tumbling mixer, drum hoop mixer or tumble dryer. This can be effected under dry protective gas to avoid moisture absorption.

The compounding is effected at adjusted cylinder temperatures of 200° C. to 340° C. In front of the nozzle, a vacuum can be applied or atmospheric degassing can take place. The melt is discharged in strand form, cooled in the water bath at 10 to 80° C. and subsequently granulated. The granulate is dried for 12 to 24 hours at 80 to 120° C. under nitrogen or in a vacuum to a water content of below 0.1% by weight.

The propellant is added to the compound or dried blend only before processing to form the foam, i.e. before coextrusion of the tubes. The homogenisation is effected as in the case of the dry blend.

According to the present invention, it is provided that the shell construction of the casing body consists of 1 to 10 inner shells, an intermediate shell and 1 to 10 outer shells. The shell construction can thereby be effected asymmetrically or even symmetrically starting from the intermediate shell Z. It is preferred if the number of shells is in total 3 to 9, preferably 3 to 7 and very particularly preferred 3 to 5. Examples of a preferred shell construction are cited subsequently. A1 thereby stands for the first shell which is disposed starting from the intermediate shell Z. A2 is then the second outer shell. The same applies to the inner shell I.
4 shells: A2/A1/Z/I1
   A1/Z/I1 /12
5 shells: A3/A2/A1/Z/I1
   A1/Z/I1/I2/I3
6 shells: A3/A2/A1/Z/I1/I2
   A2/A1/Z/I1/I2/I3

Of course, the invention thereby includes also embodiments in which also adhesive layers are provided between the shells, as explained above. The choice of adhesive layer depends upon how the shell construction has been chosen. It is also possible to incorporate an adhesive jointly in the material of the shells.

There can be added to the materials of the shells, up to 5% by weight, preferably 0.1 to 4% by weight, particularly preferred 0.1 to 2% by weight, of additives.

The additive is selected from the group consisting of inorganic stabilisers, organic stabilisers, lubricants, colour- and marking materials, inorganic pigments, organic pigments, anti-static agents, anti-blocking agents, nucleation agents, crystallisation accelerators, crystallisation inhibitors, chain-lengthening additives, mould-release agents, parting agents, optical brighteners, metallic pigments, metal tinsel, metal-coated particles, filling and reinforcing materials, in particular nanoscale filling and reinforcing materials, such as e.g. minerals with a particle size of at most 100 nm or unmodified or modified, natural or synthetic phyllosilicates or mixtures thereof.

According to the invention, also at least one shell A, I and/or Z can be coloured. The shells can also be designed differently with respect to colour. In contrast to the foamed PVC tubes which can be coloured only in pastel tones also strong colours of the entire colour spectrum, including black and white, can be produced in the case of the casing body according to the invention.

Preferred uses for the above-described casing bodies are eye shadow pencils, lip-contour pencils, eye-contour pencils, eyebrow pencils, sunscreen pencils, anti-ageing pencils, anti-acne pencils, writing pencils, crayons and/or industrial applications, such as e.g. media-guiding systems in instrument-making.

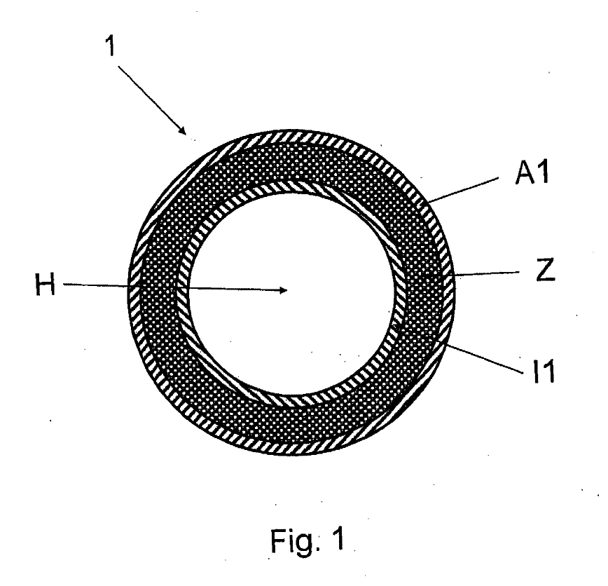

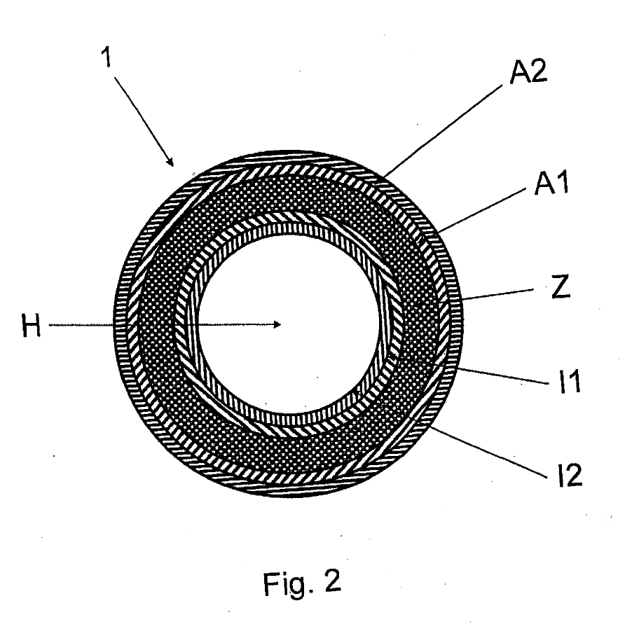

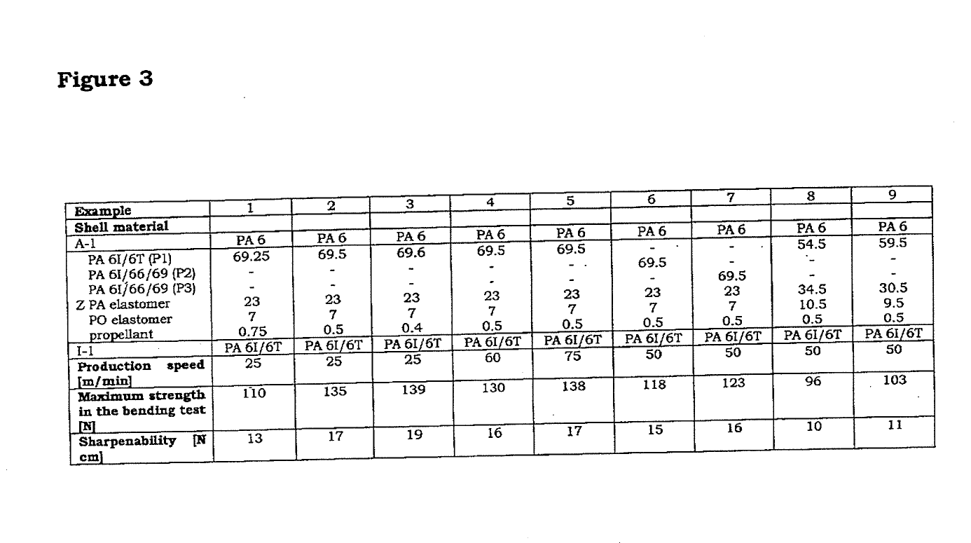

The invention is explained subsequently in more detail with reference to FIGS. 1 and 2 and the measuring results (FIGS. 3 to 6).

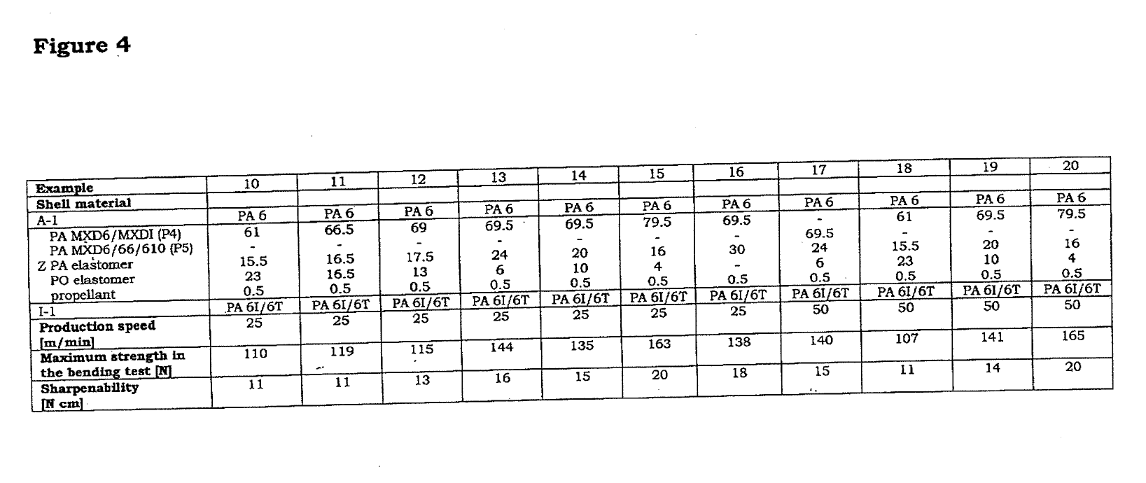

In FIG. 1, a casing body 1 according to the invention is represented in section. The casing body according to the embodiment according to FIG. 1 has a cylindrical configuration and consists of an intermediate shell Z, an outer shell A1 and also an inner shell I1. The cavity is designated with H. With a casing body according to the invention configured according to FIG. 1, tests were carried out by means of various materials and are indicated in the tables (in FIGS. 3 and 4).

For examples 1 to 20, 3-layer tubes with the dimension 7.8×1.8 mm were produced with the following materials and layer thicknesses by means of coextrusion: outer shell A1 made of PA 6 150 μm, intermediate shell Z made of polyamide foam according to the invention 1,450 μm, inner shell Il made of PA 6I/6T 200 μm. The following temperatures were thereby used: outer shell A1 260° C., intermediate shell Z 250° C., inner shell I1 230° C. The endless tube was cut into 120 mm long tubes.

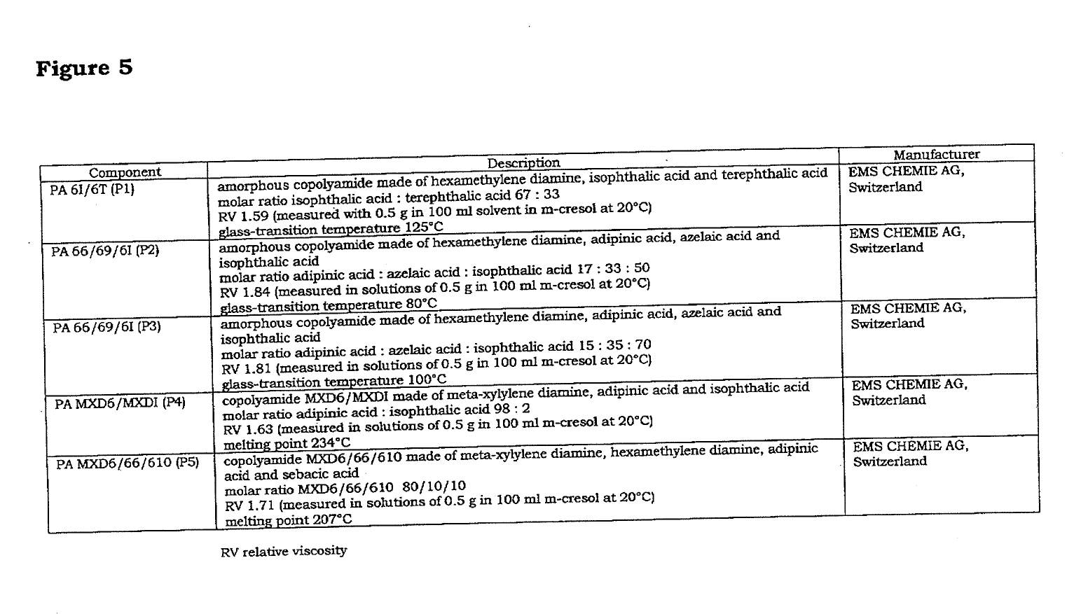

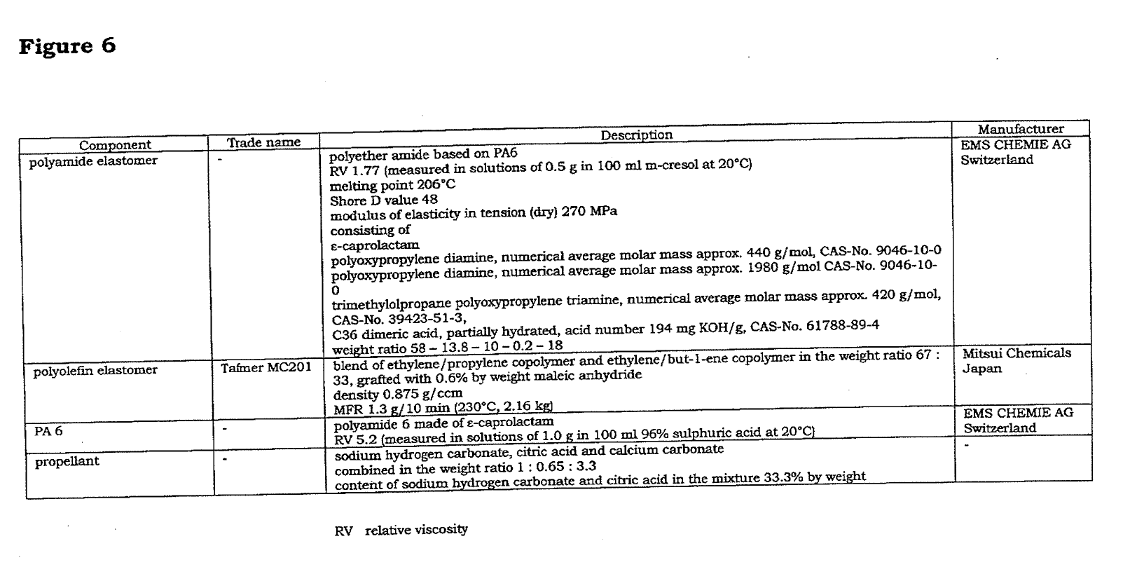

The materials used in the examples can be deduced from the tables (FIG. 5 and FIG. 6).

The following measuring specifications were used.

Relative viscosity
ISO 307
0.5% by weight m-cresol solution or 1.0% by weight solution in 96% by weight sulphuric acid
Temperature 20° C.
Calculation of the relative viscosity (RV) according to
RV =t/t₀ following section 11 of the standard.

Melting point and glass-transition temperature (Tg)
ISO-standard 11357-1/-2
Granulate
Differential scanning calorimetry (DSC) was implemented with a heating rate of 20 K/min.

In the case of the melting point the temperature is indicated at peak maximum, in the case of the glass-transition temperature the temperature is indicated at the onset.

Maximum force in the bending test
EN ISO-standard 178
120 mm long tubes of dimension 7.8×1.8 mm
Temperature: 23° C.
Test speed 2 mm/min
Span width 80 mm

The maximum strength is determined on respectively five tubes. The arithmetic mean of the measured maximum strengths is indicated in N.

Sharpenability

In order to determine the sharpenability, the torque was measured during sharpening. A commercially available pencil sharpener by KUM GmbH & Co. KG was used as sharpener: magnesium single sharpener with hard steel blade, block shape. The torque was measured by means of an electronic stirrer with torque indicator by Heidolph Instruments GmbH & Co. KG: Heidolph RZR 2051 control. The sharpener was clamped in the stirrer by means of a hand vice.

Measurement of the torque was effected at 200 rpm. For this purpose, the tube was pressed into the sharpener by means of a screw pressure spring of a standard tripod clamp and the torque maximum was read out. The measurement is carried out respectively twice on three tubes. The indicated sharpenability is the arithmetic mean of the measured maximum torques in Ncm.

As emerges from the table (FIGS. 3 and 4), the casing bodies according to the invention hence have a maximum strength in the bending test which is over 100 N and a production speed of at least 25 m/min. In some examples, the production speed is even over 50 m/min. The sharpenability is always greater than 11 N ·cm.

In comparison hereto, the production speed of monotubes made of foamed PVC is 8 to 11 m/min. With 120 mm long monotubes made of foamed PVC with dimensions 7.8×1.8 mm, a bending strength of 83 N and sharpenability of 11 N·cm was measured.

Surprisingly, the result is hence that a production speed (expressed in m/min) can be achieved with the shell construction according to the invention, which speed is significantly above that as has been known to date in the state of the art for casing bodies made of foamed PVC. In addition, reference should be made to the fact that in addition the sharpenability of the casing bodies and the maximum strength in the bending test are better than in the state of the art.

In FIG. 2, a further embodiment of a casing body according to the invention is represented. The embodiment according to FIG. 2 now shows a casing body which consists of in total 5 shells, the intermediate shell Z which consists of polyamide foam being surrounded respectively by two shells. In the embodiment according to FIG. 2, the casing body therefore has two inner shells I1 and I2 and two outer shells A1 and A2. In the embodiment according to FIG. 2, again polyamides were used respectively as shell materials.

The invention however includes also embodiments in which an asymmetrical shell construction is produced. It is hence possible to configure the casing body such that, starting outwards from the intermediate shell Z, 3 shells are provided, i.e. outer shell A1, A2 and A3, and such that the casing body then has only two inner shells I1 and 12. The number of shells is hereby based also on the application case, it is thus possible, in particular in the outer region, to fit yet an additional shell with which the haptics and/or the optical properties of the casing body can be influenced. Additional shells, e.g. made of ethylene-vinyl alcohol copolymers or polypropylene (PP), in particular in the inner region, can improve even further for example the barrier effect of the casing body relative to components of the cartridge. No adhesives are thereby required between a shell made of ethylene-vinyl alcohol copolymer and a shell which comprises polyamide and/or consists thereof.

When using a further shell which does not comprise polyamide and/or does not consist of polyamide, it can be necessary that an adhesive layer is provided between this shell, e.g. made of polypropylene, and the abutting shells.

1. A thermoplastic casing body for a pencil the casing body comprising an at least three-shell construction A, Z, I, enclosing a cavity H, wherein the construction comprises
1 to 10 outer shells A, an intermediate shell Z and 1 to 10 inner shells I, the intermediate shell Z comprising polyamide foam and/or consisting thereof and at least one of the other shells A, I comprising polyamide and/or consisting thereof.

2. The casing body according to claim 1,
wherein the intermediate shell Z is formed from polyamide foam, and has a greater layer thickness than the other layers A and I.

3. The casing body according to claim 1,
wherein the intermediate shell Z has a layer thickness of 1,000 to 3,000 μm.

4. The casing body according to claim 1,
wherein the shells of A and/or of I, have a layer thickness of 50 to 600 μm.

5. The casing body according to claim 1,
wherein it is sharpenable.

6. The casing body according to claim 1,
wherein its maximum strength in the bending test is in the range of 85 to 250 N.

7. The casing body according to claim 1,
wherein the polyamide foam is constructed from an amorphous polyamide and/or a partially crystalline polyamide and a polyamide elastomer and/or modified polyolefin elastomer.

8. The casing body according to claim 7,
wherein the polyamide foam comprises 50 to 80% by weight of polyamide, and 20 to 50% by weight of a polyamide elastomer and/or modified polyolefin elastomer.

9. The casing body according to claim 7,
wherein the glass-transition temperature of the amorphous polyamide is 90 to 210° C.,

10. The casing body according to claim 7,
wherein the melting point of the partially crystalline polyamide is 120 to 295° C.

11. The casing body according to claim 7,
wherein the polyamide elastomer is selected from polyether amides, polyester ether amides and/or polyester amides and the polyolefin elastomer is selected from an acid-modified copolyolefin elastomer and/or an acid-modified blend of a plurality of copolyolefin elastomers.

12. The casing body according to claim 1,
wherein the polyamide of the shells of A and/or of I which comprise polyamide and/or consist of polyamide is selected from aliphatic, cycloaliphatic, aromatic polyamides and/or blends hereof.

13. The casing body according to claim 12,
wherein the polyamide is selected from PA 6, PA 11, PA 12, PA 46, PA 410, PA 412, PA 66, PA 69, PA 610, PA 612, PA 1010, PA 1212, PA 6/11, PA 6/12, PA 6/66, PA 6/68, PA 6/610, PA 66/11, PA 66/12, PA 66/610, PA 6/66/11, PA 6/66/12, PA 6/66/69, PA 6/66/610, PA 6/66/612, PA 6/610/11, PA 6/610/12, PA 61, PA 6I/6T, PA 6I/66/69, PA 6I/66/610, PA 6-3-T, PA MXD6, PA MXD6/MXDI, PA MXD6/66/610, PA MXDI/6I, PA MACM12, PA PACM12, PA MACM14/1014, PA MACM12/PACM12, PA MACM14/PACM14, PA MACMI/PACMI/12, PA MACMI/12, PA MACMT/12, PA MACMI/MACMT/12, PA 6I/MACMI/12, PA 6I/6T/MACMI/MACMT, PA 6I/6T/MACMI/MACMT/12, PA MACM6/11 and PA 6I/6T/MACMI/MACMT/MACM12/612, polyether amides, polyester ether amides and/or polyester amides.

14. The casing body according to claim 1,
wherein the shells of A and of I comprise polyamide and/or consist of polyamide and the polyamides of at least two shells of A and/or of I are different.

15. The casing body according to claim 1,
wherein at least one of the shells of A and/or of I comprise polycarbonate, polyester, polyester elastomers, ethylene-vinyl alcohol copolymer and/or recycling material from the production process of the casing body (1) and/or consist thereof.

16. The casing body according to claim 1,
wherein the number of shells A, Z and I is in total 3 to 9.

17. The casing body according to claim 1,
wherein an adhesive layer is provided between at least two shells of A, I and/or Z.

18. The casing body according to claim 1,
wherein additives in a quantity of up to 5% by weight, relative to the total composition of the shell, are contained in at least one of the shells of A, I and/or Z.

19. The casing body according to claim 1,
wherein at least one shell of A, I and/or Z is coloured.

20. The casing body according to
claim 1, for encasing eye shadow pencils, lip-contour pencils, eye-contour pencils, eyebrow pencils, sunscreen pencils, anti-ageing pencils, anti-acne pencils, writing pencils, crayons and/or industrial applications.
